(19) United States
(12) Patent Application Publication
(10) Pub. No.: US 2026/0101189 A1
(43) Pub. Date: Apr. 9, 2026

(54) SOLUTIONS FOR DISTRIBUTED DENIAL OF SERVICE (DDOS) ATTACK REMEDIATION IN A NON-TERRESTRIAL NETWORK (NTN

(71) Applicant: InterDigital Patent Holdings, Inc., Wilmington, DE (US)

(72) Inventors: Alec Brusilovsky, Downingtown, PA (US); Michael Starsinic, Newtown, PA (US); Michel Roy, Candiac (CA); Anuj Sethi, Ottawa (CA); Zhibi Wang, Woodridge, IL (US); Mohamad Kenan Al-Hares, Canterbury (GB); Guanzhou Wang, Brossard (CA); Samir Ferdi, Kirkland (CA)

(73) Assignee: InterDigital Patent Holdings, Inc., Wilmington, DE (US)

(21) Appl. No.: 18/905,915

(22) Filed: Oct. 3, 2024

(51) Int. Cl. H04W 12/08; H04L 12/54

(52) U.S. Cl. CPC H04W 12/08; H04L 12/54; H04L 2012/5608

(57) ABSTRACT

Disclosed herein are solutions to remediate a distributed denial of service attack. In an example, a wireless transmit and receive unit (WTRU) transmits, to a network, a first attach request message including an store and forward (S&F) mode parameter. The WTRU receives, from the network, information indicating a puzzle and one or more parameters of the puzzle. Further, the WTRU generates evidence based on solving the puzzle. Moreover, the WTRU transmits, to the network, a second attach request message including the evidence. In an example, the WTRU receives, from the network, an attach reject message responsive to the S&F mode parameter. Additionally or alternatively, the WTRU receives, from the network, the S&F mode parameter. Additionally or alternatively, the network is a non-terrestrial network (NTN). Additionally or alternatively, the network includes a satellite. Additionally or alternatively, the includes a mobility management entity (MME) non-terrestrial (NT).

### BACKGROUND

A basic non-terrestrial network consists of an aerial or space-borne platform that, via a gateway (GW), which transports signals from a land-based gNode B (gNB) to an wireless transmit/receive unit (WTRU) and vice-versa. Support for Long Term Evolution (LTE)-based narrow-band IoT (NB-IoT) and enhanced Machine-Type Communications (eMTC) type devices was standardized. Regardless of device type, it is currently assumed that all non-terrestrial network (NTN) WTRUs are global navigation satellite system (GNSS) capable.

Aerial or space-borne platforms are classified in terms of orbit, with current standardization focusing on low-earth orbit (LEO) satellites with an altitude range of 300-1500 km and geostationary earth orbit (GEO) satellites with an altitude of 35,786 kilometers (km). Other platform classifications such as medium-earth orbit (MEO) satellites with an altitude range of 7000-25000 km and high-altitude platform stations (HAPS) with the altitude of 8-50 km are assumed to be implicitly supported. Satellite platforms are further classified as having a “transparent” or “regenerative” payload. Transparent satellite payloads implement frequency conversion and radio frequency (RF) amplification in both uplink and downlink, with multiple transparent satellites possibly connected to one land-based gNB. Regenerative satellite payloads can implement either a full gNB or gNB distributed unit (DU) onboard the satellite. Regenerative payloads may perform digital processing on the signal including demodulation, decoding, re-encoding, re-modulation, and/or filtering.

### SUMMARY

Disclosed herein are solutions to remediate a distributed denial of service attack. In an example, a wireless transmit and receive unit (WTRU) transmits, to a network, a first attach request message including an store and forward (S&F) mode parameter. The WTRU receives, from the network, information indicating a puzzle and one or more parameters of the puzzle. Further, the WTRU generates evidence based on solving the puzzle. Moreover, the WTRU transmits, to the network, a second attach request message including the evidence.

In an example, the WTRU receives, from the network, an attach reject message responsive to the S&F mode parameter. Additionally or alternatively, the WTRU receives, from the network, the S&F mode parameter. Additionally or alternatively, the S&F mode parameter is received in an S&F policy provision from the network. Additionally or alternatively, the network is a non-terrestrial network (NTN). Additionally or alternatively, the network includes a satellite. Additionally or alternatively, the includes a mobility management entity (MME) non-terrestrial (NT).

In another example, a network node receives from a WTRU, a first attach request message including an S&F mode parameter. The network node transmits, to the WTRU, based on the S&F mode parameter, information indicating a puzzle and one or more parameters of the puzzle. Moreover, the network node receives, from the WTRU, a second attach request message including evidence, wherein the evidence is responsive to the puzzle.

In an example, the puzzle is transmitted if the S&F mode parameter indicates a puzzle and an S&F policy requires puzzles. Additionally or alternatively, the network node is located in a satellite and the S&F policy is received from a terrestrial network node. Additionally or alternatively, the network node includes an MME-NT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of different radio interfaces in a non-terrestrial network (NTN);

FIG. 3A and FIG. 3B are a signaling diagram illustrating an example of remediation against an unauthenticated distributed denial of service (DDOS) attack;

FIG. 4A and FIG. 4B are a signaling diagram illustrating another example of remediation against an unauthenticated DDOS attack; and

FIG. 5A and FIG. 5B are a signaling diagram illustrating a further example of remediation against an unauthenticated DDOS attack.

### DETAILED DESCRIPTION

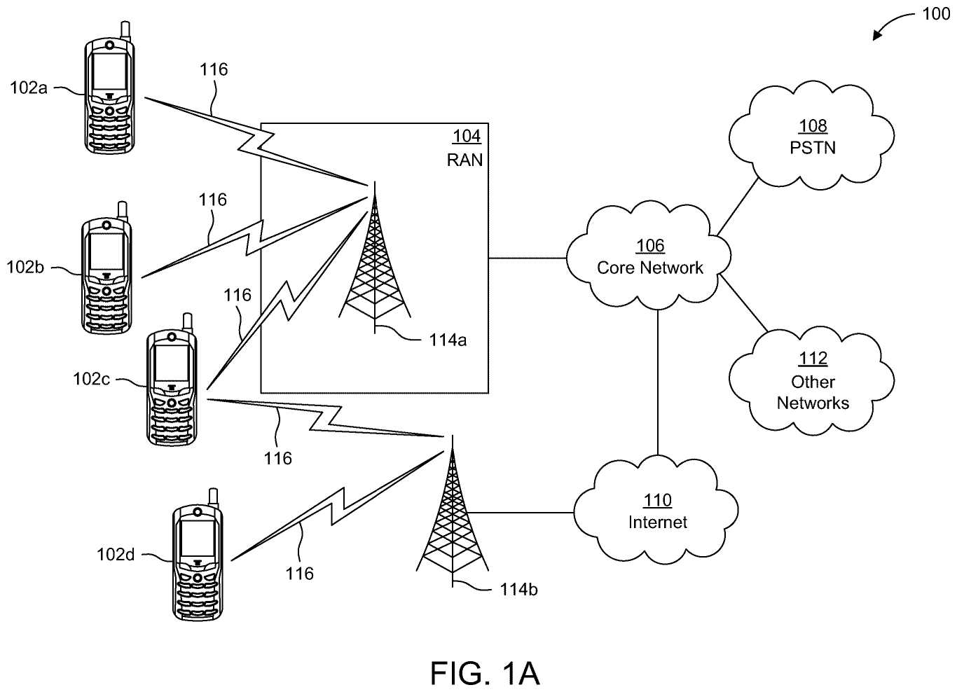

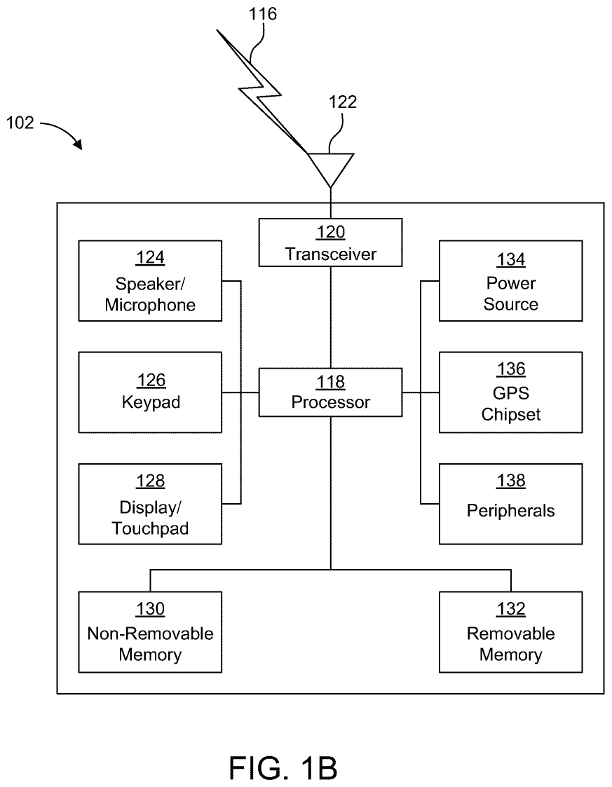

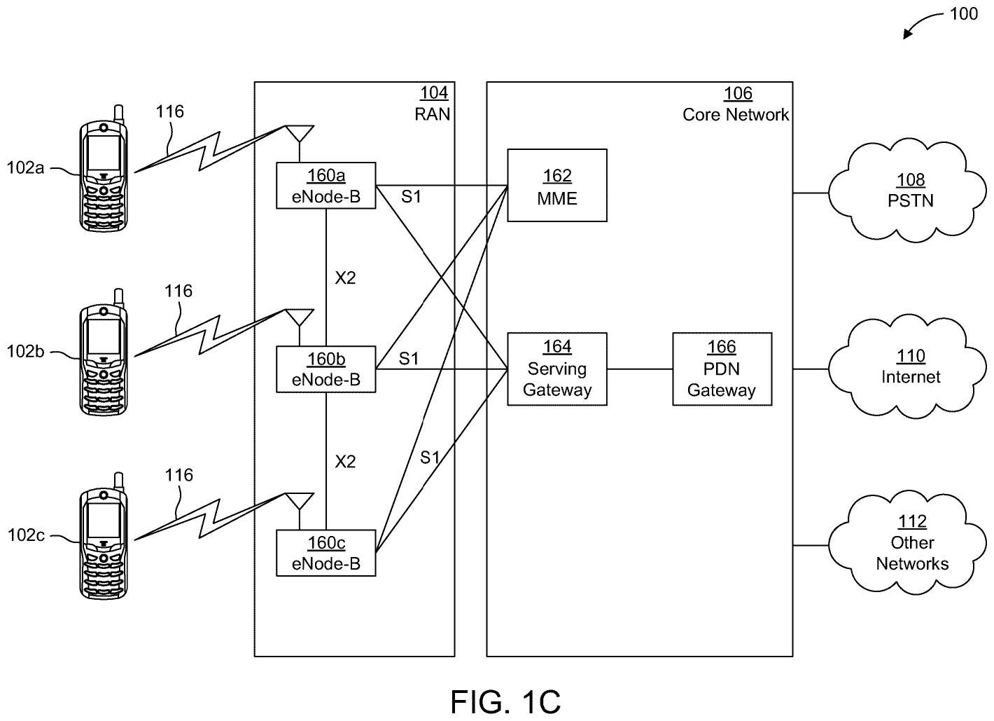

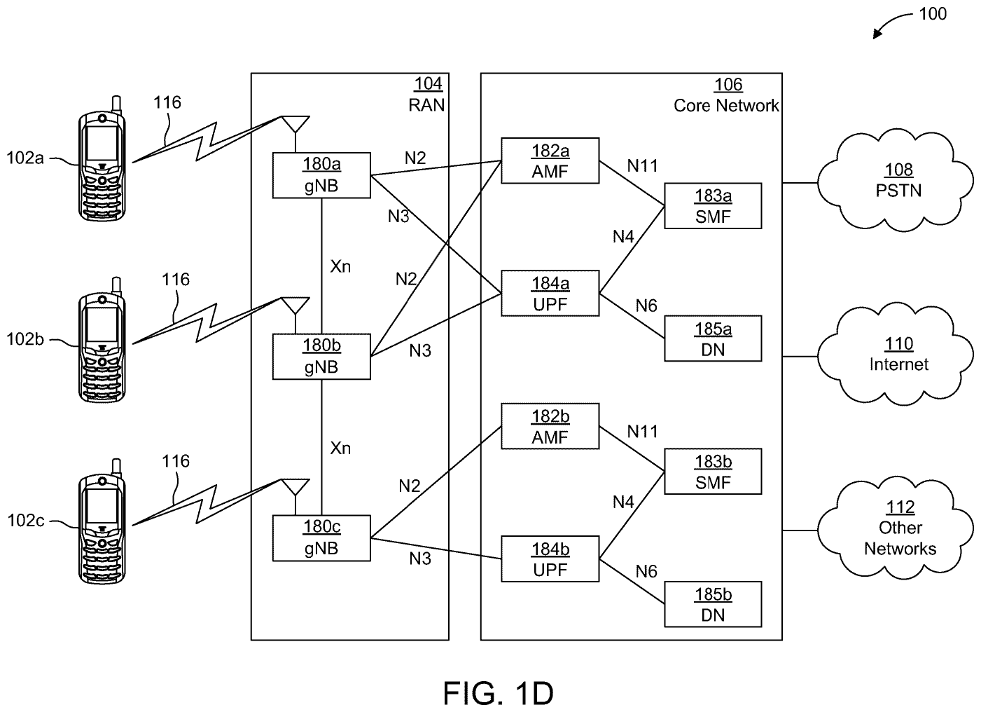

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a -d, Base Station 114a -b, eNode-B 160a -c, MME 162, SGW 164, PGW 166, gNB 180a -c, AMF 182a -b, UPF 184a -b, SMF 183a -b, DN 185a -b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

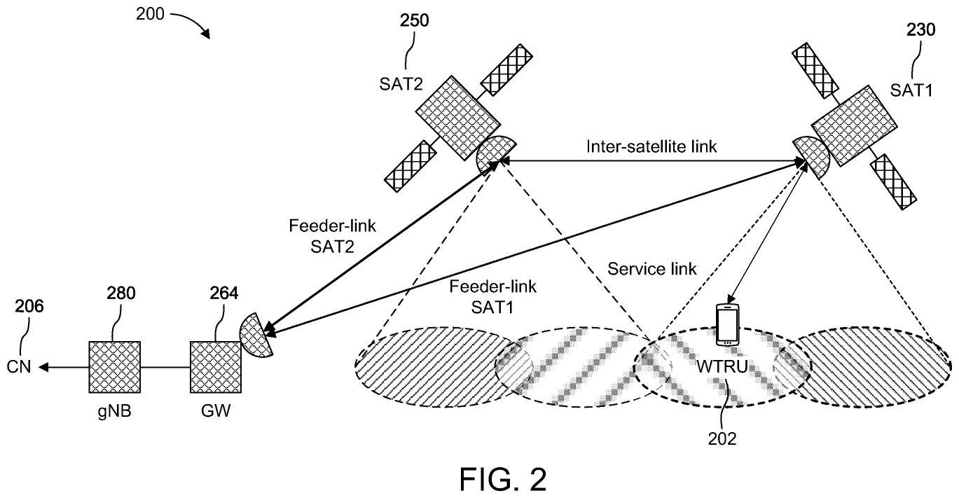

FIG. 2 is a system diagram illustrating an example of different radio interfaces in a non-terrestrial network (NTN). As shown in system diagram 200, a feeder-link may be used as a wireless link between a gateway (GW) and a satellite. For example, feeder-link SAT1 may be the wireless link between SAT1 230 and GW 264. Further, feeder-link SAT2 may be the wireless link between SAT2 250 and GW 264. Also, a service link may be used a radio link between a satellite and a WTRU. For example, SAT1 230 may use a service link to communicate with WTRU 202. In an example WTRU 202 may be the same as or similar to WTRU 102.

Further, an inter-satellite link (ISL) may be a transport link between satellites. For example, SAT1 230 may communicate with SAT2 250 via an ISL. Also, the ISL is supported only by regenerative payloads and may be a 3GPP radio or proprietary optical interface. Further GW 264 may communicate with base station 280. In an example. base station 280 may be a gNB. Further, base station 280 may access a CN 206.

An NTN satellite can support multiple cells, where each cell consists of one or more satellite beams. Satellite beams cover a footprint on earth (like a terrestrial cell) and can range in diameter from 100-1000 km in low-earth orbit (LEO) deployments, and 200-3500 km diameter in geostationary earth orbit (GEO) deployments. Beam footprints in GEO deployments remain fixed relative to Earth, and in LEO deployments the area covered by a beam/cell changes over time due to satellite movement. This beam movement can be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay are significantly larger than that of terrestrial systems. In a typical transparent NTN deployment, RTT can range from 25.77 ms (LEO @ 600 km altitude) to 541.46 ms (GEO) and maximum differential delay from 3.12 ms to 10.3 ms. The RTT of a regenerative payload is approximately half that of a transparent payload, as a transparent configuration consists of both the service and feeder links, whereas the RTT of a regenerative payload considers the service link only. To minimize impact on existing NR systems (e.g., to avoid preamble ambiguity or properly time reception windows), before initial access an WTRU performs timing pre-compensation.

The pre-compensation procedure requires the WTRU to obtain its position via global navigation satellite system (GNSS), and the feeder-link (or common) delay and satellite position via satellite ephemeris data. The satellite ephemeris data is periodically broadcast in system information, and contains the satellite speed, direction, and velocity. The WTRU will then estimate the distance (and thus delay) from the satellite, and then add the feeder-link delay component to obtain the full WTRU-eNB RTT, which is then used to offset timers, reception windows, or timing relations. It is assumed that frequency compensation is performed by the network.

Other key enhancements in NTN concern WTRU mobility and measurement reporting. As captured in 3GPP TR 38.821, the difference in reference signal received power (RSRP) between cell center and cell edge is not as pronounced as in terrestrial systems. This, coupled with the much larger region of cell overlap results in traditional measurement-based mobility becoming less reliable in an NTN environment. 3GPP has therefore introduced new conditional handover and measurement reporting triggers relying on location and time, for both NR and IoT-NTN. Enhanced mobility is of special interest in LEO deployments where, due to satellite movement, even a stationary WTRU is expected to perform mobility approximately every 7 seconds (depending on deployment characteristics).

In a store and forward (S&F) mode, the equipment on board the satellite has either connectivity over the service link (i.e., with the WTRUs) or with the terrestrial network equipment via the feeder link. If the feeder link is not available, all requests (e.g., for authentication or data transmission), including the associated upstream data have to be cached on board the satellite. Such caching presents a vulnerability that can be exploited by an adversary in mounting a distributed denial of service (DDOS) attack on the availability of the RAN and CN equipment on board the satellite. This vulnerability is recognized by current research but has not been properly and fully addressed. Embodiments and examples provided herein address this vulnerability.

There are two distinct approaches to the remediation of DDOS attacks on the availability of the equipment on board satellite during S&T operation. One approach requires a pre-provisioned, or established through prior network access (e.g., terrestrial), security context to authenticate and authorize the WTRU for NTN access. With this approach, the network equipment on board the satellite cannot authenticate and authorize WTRUs before the security association is established.

In another approach, all WTRUs are required to produce proof of work by solving puzzles. This approach requires more effort and resources from the adversarial WTRUs than from the legitimate ones and does not require a pre-provisioned security context.

Embodiments and examples provided herein added features to these approaches, as well as integrate and coordinate the use of existing DDOS remediation solutions.. For example, embodiments and examples provided herein allow the remediation of DDOS attacks before the security context is established between the WTRU and the network.

Embodiments and examples provided herein include remediation of DDOS on availability of RAN and CN equipment placed on board satellites in Store and Forward mode. An NTN may operate in S&F mode. The contents of U.S. Application No. 63/557,053, including the NTN environment in S&F mode, are incorporated by reference as if fully set forth herein.

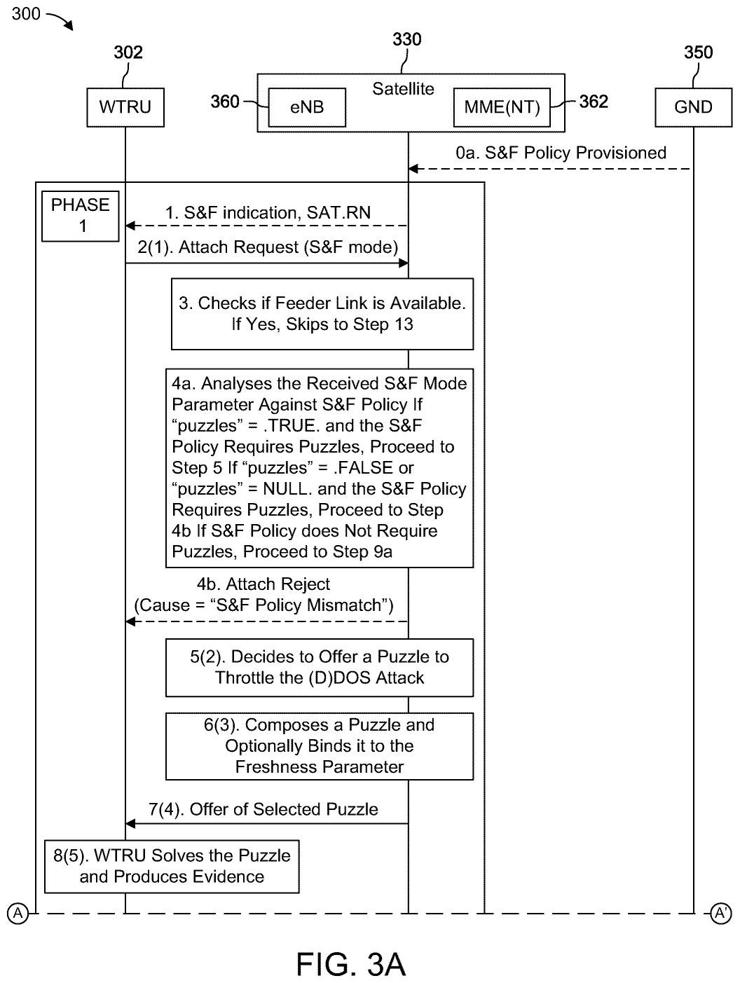

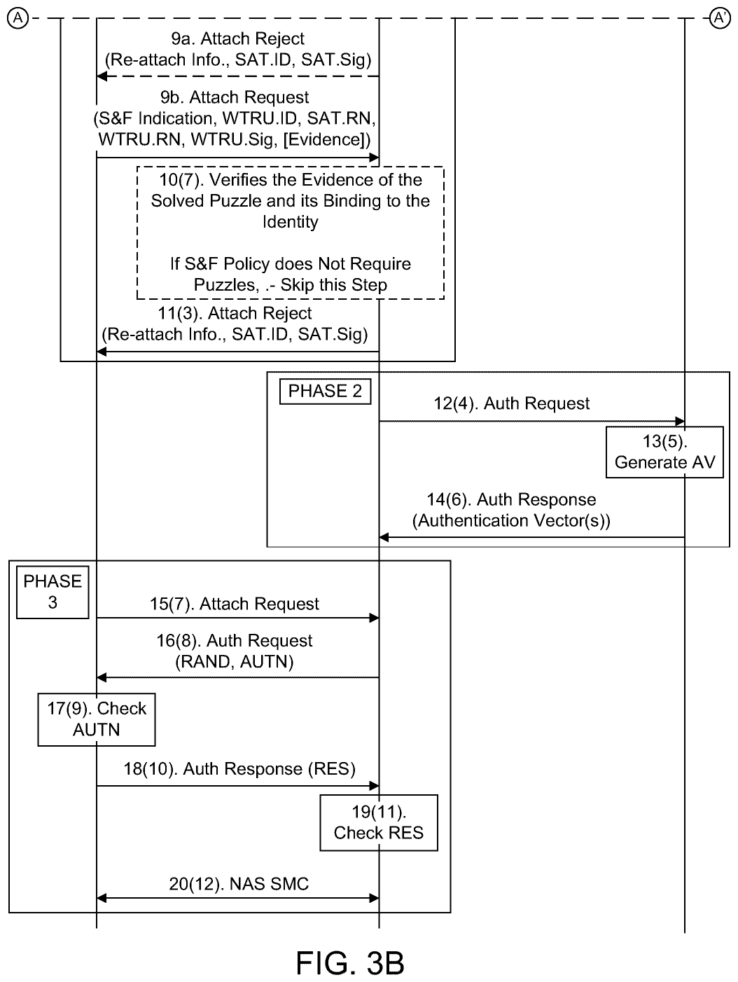

FIG. 3A and FIG. 3B are a signaling diagram illustrating an example of remediation against an unauthenticated DDOS attack. As shown in an example in signaling diagram 300, a network provisions one or more WTRUs and a satellite with a set of credentials for Elliptic Curve-Based Certificateless Signatures for Identity-Based Encryption (ECCSI). The credentials include a Public Validation Token (PVT), Secret Signing Key (SSK) associated with the WTRU's or Satellit's identity, and a key management system (KMS) Public Authentication Key (KPAK). A KMS can be a standalone entity or collocated in an existing network function (NF).

As seen in FIG. 3A, at step 0a, network equipment on board of a satellite 330 may be provisioned with an S&F policy. The S&F policy may be sent by a ground network (GND) 350. This S&F policy may include, among other values, information regarding a “puzzles required” or “puzzles not required.” The satellite 330 may include a base station 360 and an MME-non-terrestrial (NT) 362 as one or more network nodes. A WTRU 302 may be provisioned with the “S&F Mode” parameter. The S&F Mode parameter may be included in the S&F policy. Additionally or alternatively, the S&F Mode parameter may be transmitted separately from the S&F policy. In an example WTRU 302 may be the same as or similar to WTRU 102. An authentication process of the S&F mode may include the following.

In a Phase 1, a service link is available but a feeder link is unavailable. In step 1, the satellite 330 provides a random number generated by the satellite (SAT. RN) and S&F indicator indicating that the satellite 330 is operating in S&F mode. These may be included in a System Information Broadcast (SIB) message.

In step 2, the WTRU 302 issues an Attach Request message to a network node, such as eNB 360/MME 362 on board the satellite 330, including an S&F Mode parameter. In FIG. 3A and FIG. 3B, collectively FIG. 3, steps shown in parentheses may correspond to the same steps, or similar steps, currently in use. At step 3, the network node, such as eNB 360/MME 362 on board the satellite 330, checks if the feeder link is available. If yes, the eNB 360/MME 362 on board the satellite 330 may skip to step 11.

At step 4a, eNB 360/MME 362 on board the satellite 330 analyzes the received S&F Mode parameter against the S&F Policy. If “puzzles”=.TRUE. per the S&F Mode parameter, and the S&F Policy requires puzzles, the network node proceeds to step 5. If “puzzles”=.FALSE. or “puzzles”=NULL (e.g., the S&F Mode parameter is not included in message 2 and the S&F Policy requires puzzles), the network node proceeds to step 4b. If S&F Policy does not require puzzles, network node proceeds to step 9a.

At step 4b, the network node, such as eNB 360/MME 362 on board the satellite 330, issues an Attach Reject message (which may be similar to Cause=“S&F Policy Mismatch”). The WTRU 302, upon receipt of this message, is aware of its incompatibility with the S&F requirements of the network node, such as eNB 360/MME 362 on board the satellite 330.

At step 5, the network node, such as the eNB 360/MME 362 on board the satellite 330, decides to offer a puzzle to throttle one or more DDOS attacks. At step 6, the network node composes a puzzle. At step 7, the network node sends the puzzle to the WTRU 302.

At step 8, the WTRU 302 receives the puzzle, solves it, and produces the evidence. As shown in FIG. 3B, at step 9a, the network node, such as the eNB 360/MME 362 on board the satellite 330, issues the Attach Reject message with Re-attach Info, SAT. ID, SAT. Sig parameters, additionally or alternatively. Additionally or alternatively, if the S&F Policy does not require puzzles, the network node, such as the eNB 360/MME 362 on board the satellite 330, skips this step 9a.

At step 9b, the WTRU 302 initiates the attach procedure by transmitting signed Attach Request message. This message includes the Attach Request message (WTRU. ID, WTRU. RN, SAT. RN, and S&F indicator in addition to existing parameters), and digital signature. Additionally or alternatively, the message further includes the evidence produced in step 8.The WTRU. ID of the message may be generated by the WTRU 302 through ECCSI. The WTRU. ID is the WTRU's identity associated with an ECCSI algorithm, and an S&F indicator indicates that the WTRU 302 will operate in S&F mode.

The satellite 330 checks the validity of the WTRU by verifying the WTRU. Sig. Specifically, at step 10, the network node, such as the eNB 360/MME 362 on board the satellite 330, verifies the evidence from step 8(2). Additionally or alternatively, if the S&F Policy does not require puzzles, the eNB/MME on board the satellite skips this step.

At step 11, if the verification is successful, the satellite stores the received attach request message and transmits the signed Attach Reject message. This message consists of the Attach Reject message (SAT. ID, and Re-attach Info) and digital signature which is generated by the satellite using the Attach Reject message and WTRU. RN through the ECCSI algorithm. The SAT. ID is the satellite's identity associated with ECCSI algorithm and the Re-attach Info is information necessary for the WTRU 302 to attempt the reconnection in step 7 (e.g., information about when the WTRU should retry to reconnect or list of satellite(s) that the WTRU should retry to reconnect).

The WTRU checks the validity of the satellite by verifying the SAT. Sig. If verified, WTRU waits for step 7 based on the guideline received.

In a Phase 2, the service link is unavailable and the feeder link is available. At step 12, the network node in the satellite 330 requests authentication data for the WTRU 302 by sending the Authentication Data Request message to the GND 350. The request includes one or more of: an international mobile subscriber identity (IMSI), a subscriber permanent identifier, a serving network (SN) identity, or a Network type.

At step 13, upon the receipt of the Authentication Data Request from the satellite 330, the home subscriber server (HSS) in the GND 350 generates authentication vector(s). In an example, the authentication vector(s) may be as defined in clause 6.3.2 in 3GPP TS 33.102. The authentication vector includes the parameters K_{ASME}, RAND, AUTN, and XRES.

At step 14, the GND 350 an authentication response back to the satellite that contains the authentication vector(s).

In a Phase 3, the service link is available and the feeder link is unavailable. Additionally or alternatively, the satellite in this phase may be different from the satellite in Phase 1.

At step 15, the WTRU 302 retries the network connection by transmitting the Attach Request. This message can be protected using the similar method to step 2.

At step 16, the sends Authentication Request including the AUTN and RAND. At step 17, at the receipt of the RAND and AUTN, the WTRU 302 verifies the freshness of the received values by checking whether the AUTN can be accepted. In an example, the checking may be as described in 3GPP TS 33.102. If so, the WTRU 302 computes a response RES parameter.

At step 18, the WTRU 302 responds with an Authentication Response message including RES in case of a successful AUTN verification. In this case, the WTRU 302 computes K_{ASME} from CK, IK, and the serving network's identity.

At step 19, the satellite checks that the RES equals XRES. If so, the authentication is successful. As a result of the authentication and key agreement, an intermediate key K_{ASME} is shared between the WTRU 302 and the satellite.

At step 20, a NAS security mode command (SMC) procedure is performed between the WTRU 302 and the satellite. Additionally or alternatively, the dynamic variation of SAT. RN and WTRU. RN hardens the security against DOS attack.

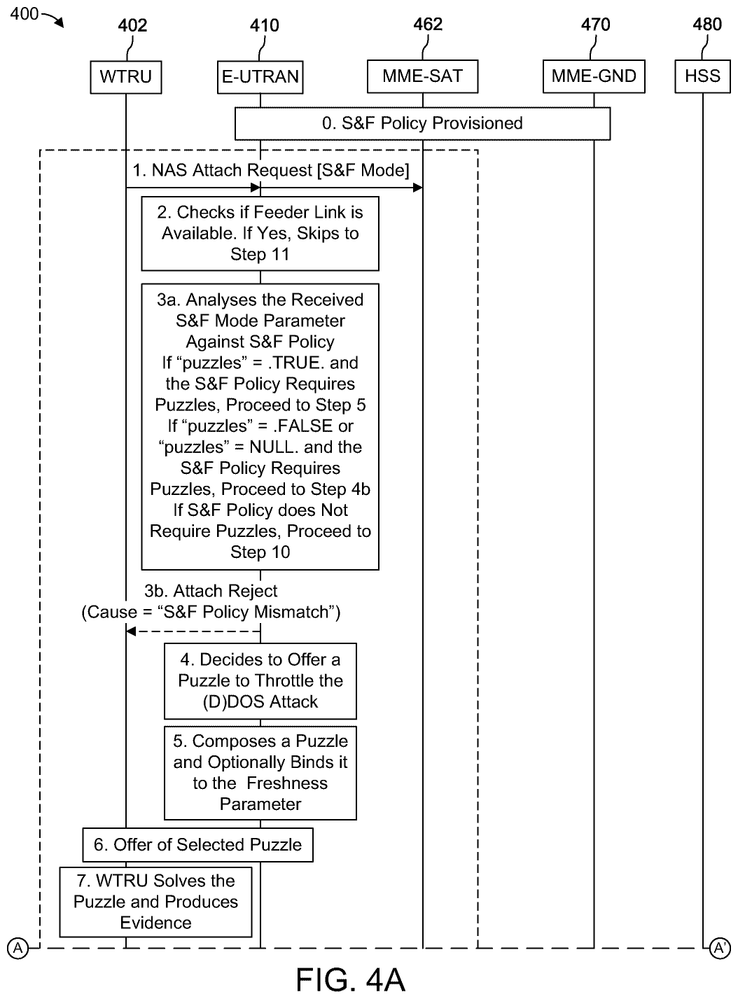

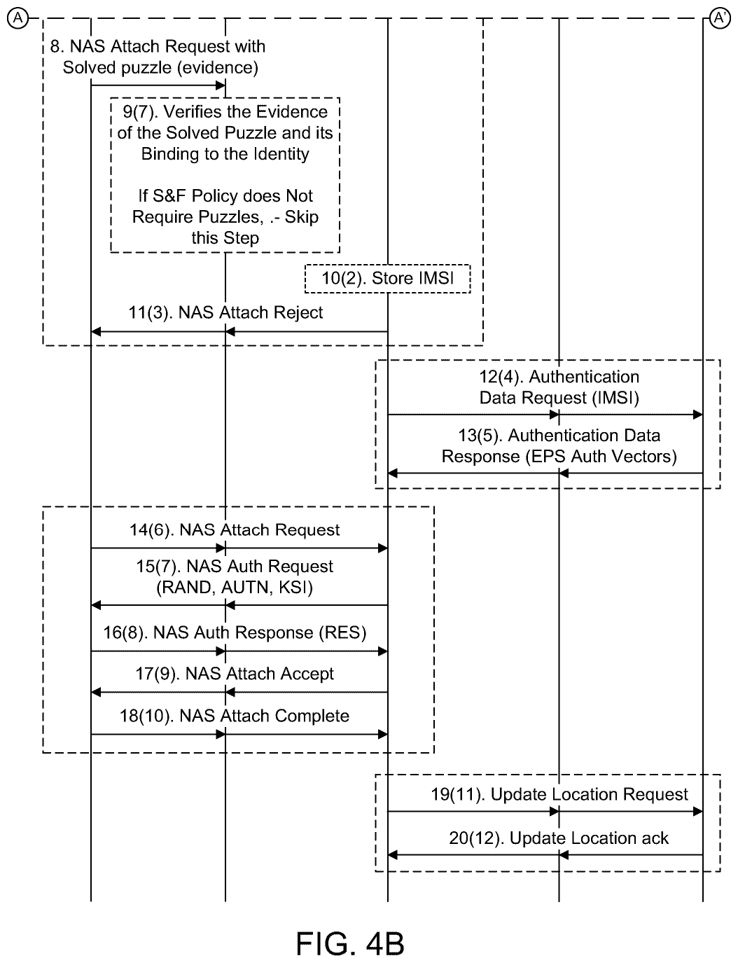

FIG. 4A and FIG. 4B are a signaling diagram illustrating another example of remediation against an unauthenticated DDOS attack. As shown in an example in signaling diagram 400, at step 0, network equipment or a network node on board of a satellite may be provisioned with an S&F policy. In an example, the network node may be an E-UTRAN network node 410 on board the satellite. Additionally or alternatively, the network node is an MME-SAT 462. Additionally or alternatively, the network node is an MME-GND 470. Additionally or alternatively, the S&F policy may be sent by the MME-GND 470. This S&F policy may include, among other values, information regarding a “puzzles required” or “puzzles not required.” A WTRU 402 may be provisioned with the “S&F Mode” parameter. The S&F Mode parameter may be included in the S&F policy. Additionally or alternatively, the S&F Mode parameter may be transmitted separately from the S&F policy. In an example WTRU 402 may be the same as or similar to WTRU 102.

Further, as shown in example in FIG. 4A and FIG. 4B, collectively FIG. 4, in an initial registration process at step 1, upon entering the satellite's coverage, the WTRU 402 initiates an Initial Attach Request with the S&F Mode parameter. This S&F Mode parameter may be sent to the E-UTRAN network node 410, in an example. Additionally or alternatively, this S&F Mode parameter is then forward by the E-UTRAN network node 410 to the MME-SAT 462. Additionally or alternatively, this S&F Mode parameter is sent directly to MME-SAT 462.

At step 2, the E-UTRAN network node 410 on board the satellite checks if the Feeder link is available. If yes, the authentication process skips to step 10.

At step 3a, a base station on board the satellite, such as an eNB or the E-UTRAN network node 410, analyzes the received S&F Mode parameter against the S&F Policy. If “puzzles”=.TRUE. per the S&F Mode parameter, and the S&F Policy requires puzzles, the network node proceeds to step 5. If “puzzles”=.FALSE. or “puzzles”=NULL (e.g., the S&F Mode parameter is not included in message 2 and the S&F Policy requires puzzles), the network node proceeds to step 3b. If S&F Policy does not require puzzles, the procedure proceeds to step 10. At step 3b, the network node issues an Attach Reject message (which may be similar to Cause=“S&F Policy Mismatch”).

At step 4, the network node on board the satellite, decides to offer a puzzle to throttle one or more DDOS attacks. At step 5, the network node composes a puzzle. At step 6, the network node sends the puzzle to the WTRU 402.

At step 7, the WTRU 402 receives the puzzle, solves it, and produces the evidence. As shown in FIG. 4B, at step 8, the WTRU 402 issues a NAS Attach Request from to the network node on board the satellite with the solved puzzle (evidence).

At step 9, the network node on board the satellite verifies the evidence from step 8, additionally or alternatively. Additionally or alternatively, if the S&F Policy does not require puzzles, the network node on board the satellite skips this step 9. In FIG. 4B, steps shown in parentheses may correspond to the same steps, or similar steps, currently in use.

At step 10, the MME-SAT 462, unable to immediately establish a ground connection, temporarily stores the WTRU's International Mobile Subscriber Identity (IMSI) and issues an Attach Reject message. Further, the MME-SAT 462, unable to immediately establish a ground connection, temporarily stores the WTRU's International Mobile Subscriber Identity (IMSI) and issues a NAS Attach Reject message at step 11. The MME-SAT 462 rejects the WTRU's Initial Attach Request with an Attach Reject message that includes a Cause value indicating that the Attach procedure is suspended, as well as a Timer value (indicating how long the WTRU should refrain from attempting another Attach). Additionally or alternatively, the Cause and the Timer can be protected with a digital signature, which the WTRU can validate using provisioned root certificates.

Once the MME-SAT 462 establishes contact with MME-GND, it forwards the IMSI to request authentication vectors from the Home Subscriber Server (HSS) 480. For example, the MME-SAT 462 sends an authentication data request (with IMSI) to HSS 480 at step 12. The request may be sent via MME-GND 470. Further, the HSS 480 may then send an authentication data response (with EPS Auth Vectors) to MME-SAT 462. The response may be sent via MME-GND 470.

In subsequent coverage, the WTRU 402 re-initiates the Attach Request. This time, the MME-SAT 462, equipped with the authentication vectors, proceeds to authenticate the WTRU 402, leading to a successful Attach Acceptance. For example, at step 14, the WTRU 402 sends a NAS attach request to the MME-SAT 462. The MME-SAT 462 then sends a NAS Auth Request to WTRU 402 at step 15. Further, at step 16, the WTRU sends a NAS attach Auth Response (RES) to the MME-SAT 462. The MME-SAT 462 then sends a NAS Attach Accept to WTRU 402 at step 17. Moreover, the WTRU 402 send a NAS Attach Complete to the MME-SAT 462 at step 18.

Immediately following successful authentication, the MME-SAT 462 sends a provisional Update Location Request to the HSS 480 at step 19. This update includes an indicator that the location update is provisional and should not be fully processed until final confirmation is received, optimizing the handling of location data under intermittent connectivity. Further, the HSS 480 sends an update location acknowledgement to MME-SAT 462 at step 20.

In a location update process, the MME-SAT 462 updates the WTRU's 402 location with the HSS 480 upon establishing ground connectivity, ensuring the WTRU's 402 subscription permits service in the attempted location. Any discrepancies trigger a detach procedure during the next satellite contact.

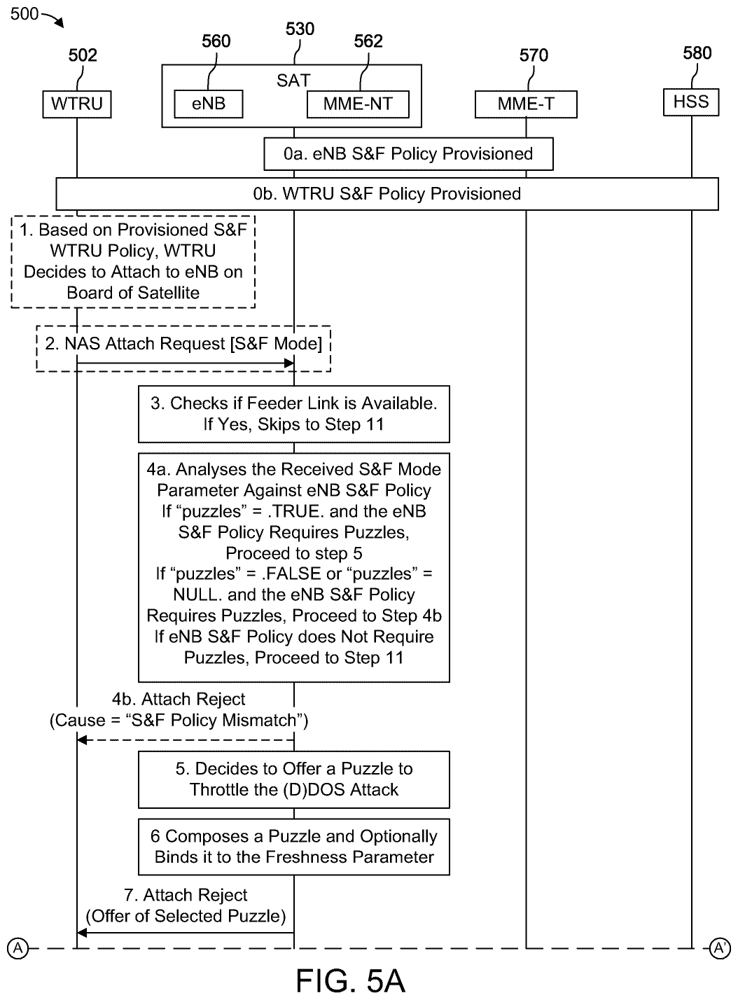

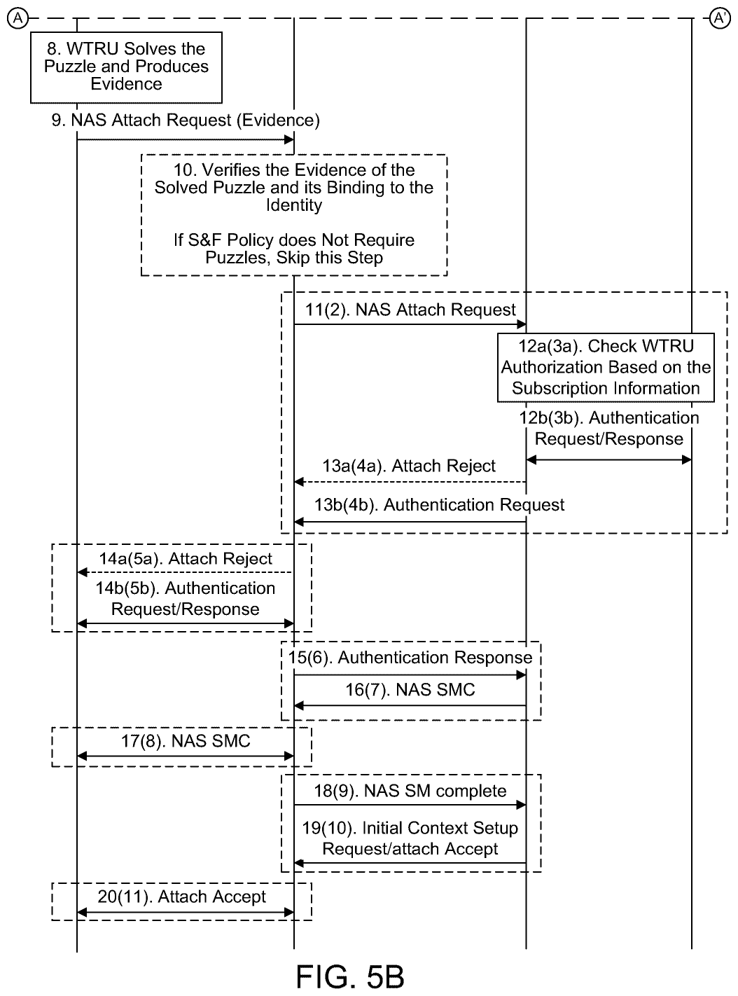

FIG. 5A and FIG. 5B are a signaling diagram illustrating a further example of remediation against an unauthenticated DDOS attack. As shown in signaling diagram 500, a WTRU 502 may initiate a NAS attach request, at step 2. Before step 2, a network node, such as eNB 560 on board a satellite 530, may receive S&F policy provisioning at step 0, additionally or alternatively. Additionally or alternatively, the WTRU 502 decides, based on the WTRU S&F policy, what parameter in S&F Mode to send to the eNB 560 on board the satellite 530 in an Attach Request, to then be forwarded to the MME-NT 562. An S&F Mode parameter can be, for example, one or more of the following: “puzzles”, “credentials”, and both “puzzles” and “credentials.” The intent of using the S&F Mode parameter is to communicate to the eNB 560 on board of the satellite 530 the WTRU 502 policy regarding the remediation of (D)DOS attacks in S&F.

The WTRU 502 initiates the attach procedure by sending the Attach Request with included S&F Mode parameter to the MME-NT 562 on board the satellite 530, at step 2. The network node, such as the eNB 560 or the MME-NT 562 on board the satellite 530, checks if the Feeder link is available at step 3. If yes, skip to step 11.

At step 4a, the network node, such as the eNB 560 on board the satellite 530, analyses the received S&F Mode parameter received in step 2 against S&F Policy. If “puzzles”=.TRUE. and the S&F Policy requires puzzles, the network node proceeds to step 5. If “puzzles”=.FALSE. or “puzzles”=NULL (e.g., the S&F Mode parameter is not included in message 2) and the S&F Policy requires puzzles, the network node proceeds to step 4b. If S&F Policy does not require puzzles, the network node proceeds to step 11.

At step 4b, the network node, such as the eNB 560 on board the satellite 530, issues an Attach Reject message (with Cause=“S&F Policy Mismatch”). At step 5, the network node, such as the eNB 560 or the MME-NT 562 on board the satellite 530, decides to offer a puzzle to throttle (D)DOS attack.

At step 6, the network node, such as the eNB 560 or the MME-NT 562 on board the satellite 530, composes a puzzle. At step 7, the network node, such as the eNB 560 or the MME-NT 562 on board the satellite 530, sends a puzzle to the WTRU 502 using the Attach Reject message.

As shown in FIG. 5B, at step 8, the WTRU 502 solves the puzzle and produces the evidence. At step 9, the WTRU 502 sends the evidence obtained in step 8 to the network node, such as the eNB 560 or the MME-NT 562 on board the satellite 530, using the NAS Attach Request message.

At step 10. the network node, such as the eNB 560 or the MME-NT 562 on board the satellite 530, verifies the evidence from step 9. the If S&F Policy does not require puzzles, the network node, such as the eNB 560 or the MME-NT 562 on board the satellite 530, skips this step.

In FIG. 5B, steps shown in parentheses may correspond to the same steps, or similar steps, currently in use. At step 11, if the feeder link is unavailable, the MME-NT 562 temporarily stores NAS signaling from the WTRU 502. When the feeder link becomes available, the MME-NT 562 forwards NAS signaling to an MME-T 570, including the S&F indication, as in the NAS Attach Request.

At steps 12a and 12b, the MME-T 570 interacts with the HSS 580 to obtain the WTRU subscription information for initiating the authentication procedure. At step 13b, if the WTRU 502 is authorized to use an S&F service operation, the MME-T 570 returns the authentication request to the MME-NT 562. If the WTRU 502 is not authorized, the MME-T 570 returns the Attach Reject to the MME-NT 562, at step 13a.

At step 14, if the service link is unavailable, the MME-NT 562 temporarily stores NAS signaling from the core network. When the service link becomes available, the MME-NT forwards NAS signaling to the WTRU 502, which can be the Attach Reject message at step 14a or an Authentication Request/Response message at step 14b. If the WTRU 502 is authorized to use an S&F service operation, step 14b is executed. Otherwise, step 14a is performed.

If the WTRU 502 receives an Attach Reject message, the WTRU 502 stops the attach procedure and waits to re-initiate the Attach procedure until the satellite can establish the service link and feeder link at the same time. Additionally or alternatively, steps 15-20 are then skipped.

If the WTRU 502 receives an authentication request message, the WTRU 502 returns an authentication response to the MME-NT 562.

At step 15, when the feeder link becomes available, the MME-NT 562 sends an authentication response to the MME-T 570. At step 16, the MME-T 570 returns a NAS Security Mode Command (SMC) message. At step 17, when the service link becomes available, the WTRU 502 performs the NAS SMC procedure.

Further at step 18, when the feeder link becomes available, the MME-NT 562 sends a NAS SM Complete message to MME-T 570. At step 19, the MME-T 570 sends the initial context setup request/attach accept. Moreover, at step 20, when the service link becomes available, the MME-NT 562 forwards the Attach accept message to the WTRU 502.

In an example, a WTRU transmits, to a network, a first attach request message including an S&F mode parameter. The WTRU receives, from the network, information indicating a puzzle and one or more parameters of the puzzle. Further, the WTRU generates evidence based on solving the puzzle. Moreover, the WTRU transmits, to the network, a second attach request message including the evidence. In an example, the WTRU receives, from the network, an attach reject message responsive to the S&F mode parameter. Additionally or alternatively, the WTRU receives, from the network, the S&F mode parameter. Additionally or alternatively, the S&F mode parameter is received in an S&F policy provision from the network. Additionally or alternatively, the network is a NTN. Additionally or alternatively, the network includes a satellite. Additionally or alternatively, the includes an MME-NT.

In another example, a network node receives from a WTRU, a first attach request message including an S&F mode parameter. The network node transmits, to the WTRU, based on the S&F mode parameter, information indicating a puzzle and one or more parameters of the puzzle. Moreover, the network node receives, from the WTRU, a second attach request message including evidence, wherein the evidence is responsive to the puzzle.

In an example, the puzzle is transmitted if the S&F mode parameter indicates a puzzle and an S&F policy requires puzzles. Additionally or alternatively, the network node is located in a satellite and the S&F policy is received from a terrestrial network node. Additionally or alternatively, the network node includes an MME-NT.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit and receive unit (WTRU), the method comprising:
transmitting, to a network, a first attach request message including a store and forward (S&F) mode parameter;
receiving, from the network, information indicating a puzzle and one or more parameters of the puzzle;
generating evidence based on solving the puzzle; and
transmitting, to the network, a second attach request message including the evidence.

2. The method of claim 1, further comprising:
receiving, from the network, an attach reject message responsive to the S&F mode parameter.

3. The method of claim 1, further comprising:
receiving, from the network, the S&F mode parameter.

4. The method of claim 3, wherein the S&F mode parameter is received in an S&F policy provision from the network.

5. The method of claim 1, wherein the network is a non-terrestrial network (NTN).

6. The method of claim 1, wherein the network includes a satellite.

7. The method of claim 1, wherein the network includes a mobility management entity (MME) non-terrestrial (NT).

8. A network node comprising:
a transceiver operatively coupled to a processor; wherein the network node is configured to:
receive, from a wireless transmit and receive unit (WTRU), a first attach request message including a store and forward (S&F) mode parameter;
transmit, to the WTRU, based on the S&F mode parameter, information indicating a puzzle and one or more parameters of the puzzle; and
receive, from the WTRU, a second attach request message including evidence, wherein the evidence is responsive to the puzzle.

9. The network node of claim 8, wherein the puzzle is transmitted if the S&F mode parameter indicates a puzzle and an S&F policy requires puzzles.

10. The network node of claim 9, wherein the network node is located in a satellite and the S&F policy is received from a terrestrial network node.

11. The network node of claim 10, wherein the network node includes an mobility management entity (MME) non-terrestrial (NT).

12. A wireless transmit and receive unit (WTRU) comprising:
a transceiver operatively coupled to a processor; wherein the WTRU is configured to:
transmit, to a network, a first attach request message including a store and forward (S&F) mode parameter;
receive, from the network, information indicating a puzzle and one or more parameters of the puzzle;
generate evidence based on solving the puzzle; and
transmit, to the network, a second attach request message including the evidence.

13. The WTRU of claim 12, wherein the WTRU is further configured to:
receive, from the network, an attach reject message responsive to the S&F mode parameter.

14. The WTRU of claim 12, wherein the WTRU is further configured to:
receive, from the network, the S&F mode parameter.

15. The WTRU of claim 14, wherein the S&F mode parameter is received in an S&F policy provision from the network.

16. The WTRU of claim 12, wherein the network is a non-terrestrial network (NTN).

17. The WTRU of claim 12, wherein the network includes a satellite.

18. The WTRU of claim 12, wherein the network includes a mobility management entity (MME) non-terrestrial (NT).
